(19) United States
(12) Patent Application Publication
(10) Pub. No.: US 2024/0430514 A1
(43) Pub. Date: Dec. 26, 2024

(54) ELECTRONIC PROGRAMMING GUIDE (EPG) FOR ACCESSING LINEAR CHANNELS AND DYNAMIC CHANNELS

(71) Applicant: Philo, Inc., San Francisco, CA (US)

(72) Inventors: Andrew McCollum, San Francisco, CA (US); Devon Ray WILLIAMS, Berkeley, CA (US); Leila Tudury, Danville, CA (US); Thomas Rundle, San Francisco, CA (US); Jerry Luke, San Francisco, CA (US); Jane Slaughter, Irvine, CA (US); Ravali Peddi, Dublin, CA (US); Benjamin Paul Clemens, Berkeley, CA (US)

(73) Assignee: Philo, Inc., San Francisco, CA (US)

(21) Appl. No.: 18/752,630

(22) Filed: Jun. 24, 2024

Related U.S. Application Data
(60) Provisional application No. 63/510,099, filed on Jun. 23, 2023.

(51) Int. Cl. H04N 21/431; H04N 21/262; H04N 21/2668; H04N 21/442; H04N 21/482

(52) U.S. Cl. CPC H04N 21/4316; H04N 21/26258; H04N 21/2668; H04N 21/44204; H04N 21/4821

(57) ABSTRACT

An embodiment is a method performed by a media delivery system. The method includes selecting video assets to be included in a dynamic channel for a user based on a user profile of the user. The method further includes causing a client device to display an electronic programming guide (EPG) graphical user interface (GUI), wherein the EPG GUI displays time schedule information for one or more linear channels alongside information regarding a first video asset from the plurality of video assets included in the dynamic channel, wherein the EPG GUI further displays a first GUI element that is activatable by the user to cause the first video asset to be played for the user and a second GUI element that is activatable by the user to cause the EPG GUI to display information regarding a second video asset included in the dynamic channel.

### CROSS-REFERENCE TO RELATED APPLICATIONS

This application claims the benefit of U.S. Provisional Application No. 63/510,099, filed Jun. 23, 2023, which is hereby incorporated by reference.

### TECHNICAL FIELD

Embodiments relate generally to streaming video and, more specifically, to providing an electronic programming guide (EPG) for accessing linear channels and dynamic channels.

### BACKGROUND

An over-the-top (OTT) media delivery service is a media delivery service that delivers video content to viewers via the Internet. OTT media delivery services are often associated with a subscription-based video on demand (SVOD) service that offers its subscribers access to a collection of video content (including existing television (TV) shows and movies for which rights have been acquired from the content owner, as well as original content produced specifically for the service). OTT media delivery services can also include a range of “skinny” television offerings that provide access to live streams of linear specialty channels. These services resemble traditional satellite or cable TV services, but the content is delivered via the public Internet instead of a closed, private network with exclusive equipment like set-top boxes.

Video on demand (VOD) services allow users to browse through a catalog of video assets (e.g., TV shows and movies) and choose which video assets to watch. While this provides flexibility for the user, the user may be faced with a paradox of choice, where the user spends a long time browsing through the catalog trying to find a video asset to watch. Traditional linear TV channels provide the user with a “laid back” experience where the user does not need to actively choose what to watch. However, traditional linear TV channels show the same video content to all users according to a predetermined schedule, and thus do not provide any personalization.

### BRIEF DESCRIPTION OF THE DRAWINGS

Various embodiments in accordance with the present disclosure will be described with reference to the drawings, in which:

FIG. 1 is a diagram showing a video streaming environment, according to some embodiments.

FIG. 2 is a flow diagram of a method for providing an EPG GUI, according to some embodiments.

FIG. 3 is a flow diagram of a method for providing an EPG GUI, according to some embodiments.

FIG. 4 is a diagram showing an EPG GUI, according to some embodiments.

FIG. 5 is a diagram showing another EPG GUI, according to some embodiments.

FIG. 6 is a diagram showing another EPG GUI, according to some embodiments.

FIG. 7 is a diagram showing another EPG GUI, according to some embodiments.

FIG. 8 is a diagram showing another EPG GUI, according to some embodiments.

FIG. 9 is a diagram showing another EPG GUI, according to some embodiments.

FIG. 10 is a diagram showing another EPG GUI, according to some embodiments.

FIG. 11 is a diagram showing another EPG GUI, according to some embodiments.

FIG. 12 is a diagram showing a playback GUI, according to some embodiments.

FIG. 13 is a diagram showing another playback GUI, according to some embodiments.

FIG. 14 is a block diagram showing a video streaming system, according to some embodiments.

FIG. 15 is a diagram showing a video streaming system architecture, according to some embodiments.

### DETAILED DESCRIPTION

Various embodiments of methods, apparatus, systems, and non-transitory computer-readable storage media are described for providing an electronic programming guide (EPG) for accessing linear channels and dynamic channels.

In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device (or computing device) stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

As reflected earlier, an electronic device can take a variety of forms, including a client electronic device (also referred to as a client computing device or client device) that implements a media player application that plays video content streamed over a communication network on a display screen. Such a client device may be operated by a user and have one or more user input mechanisms, such as a keyboard, touchscreen, remote control, etc. The user may interact with the one or more user input mechanisms to access video content (e.g., TV shows, movies, live streams, etc.) offered by a media delivery service. Such client devices may come in a variety of sizes, including relatively large (e.g., a smart TV, a set top box without a screen and intended to be connected to a display screen (such as a TV), or a desktop computer connected to a display screen (such as a monitor)) and relatively small (e.g., a mobile device such as a laptop, smart phone, or smart watch with an integrated (and optionally touchscreen) display screen).

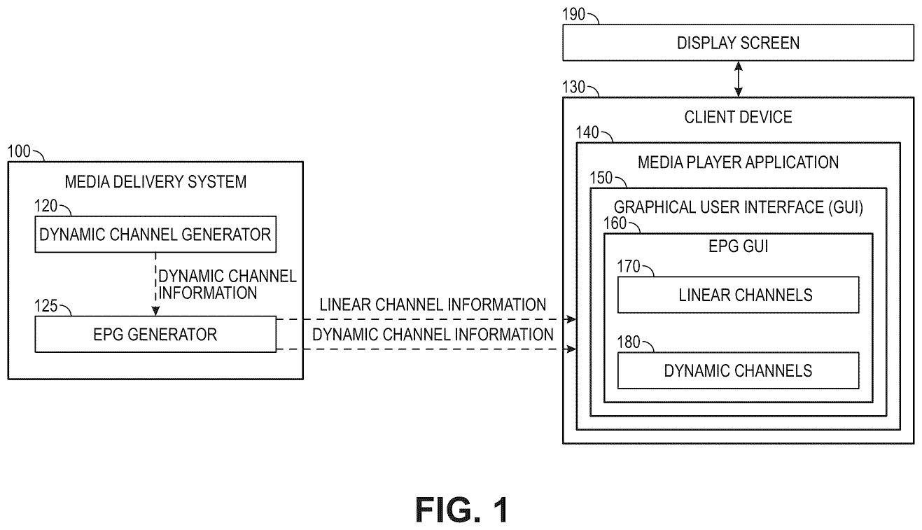

FIG. 1 is a diagram showing a video streaming environment, according to some embodiments. As shown in the diagram, the video streaming environment includes a media delivery system 100 and a client device 130. The media delivery system 100 may be a system that provides a media delivery service to users by streaming live/broadcast and/or on-demand video content offered by the media delivery service to one or more client devices (e.g., client device 130) over a communication network (e.g., the Internet). The media delivery system may include one or more computing devices that coordinate with each other to provide the media delivery service. For sake of simplicity, the diagram shows the video streaming environment as including a single client device 130. However, it should be appreciated that the video streaming environment can and typically will include more than one client device 130.

The client device 130 may be operated by a user and implement a media player application 140 that can play video content streamed by media delivery system 100 on a display screen 190 coupled to the client device 130. While the diagram shows the display screen 190 as being separate from the client device 130 (e.g., the display screen 190 may be a TV or monitor connected to the client device 130 via a wired or wireless connection), in some embodiments, the display screen 190 is integrated with the client device 130 (e.g., if the client device 130 is a smartphone, tablet, etc.). In an embodiment, the media player application 140 is an application or mobile app that can be downloaded (e.g., from an online application/app store) and installed on the client device 130 by the user. In an embodiment, the media player application 140 comes installed on the client device 130 from the factory. The media player application 140 may provide a graphical user interface (GUI) 150 that allows the user to browse and access video content offered by the media delivery service. The user may interact with the GUI 150 using one or more input mechanisms of the client device 130 (e.g., touchscreen, remote control, keyboard, mouse, touchpad, voice commands, etc.).

The media delivery service may offer linear channels and dynamic channels. A linear channel may be a channel that plays video content according to a predetermined schedule that is the same for multiple users of the media delivery service provided by the media delivery system 100. In contrast, a dynamic channel 180 may be a channel that includes video content that is dynamically assembled on-the-fly and personalized on a per-user basis. If the user of the client device 130 chooses to watch a particular channel (e.g., by interacting with the GUI 150), the media delivery system 100 may stream the video content of the particular channel (e.g., which may be a linear channel or dynamic channel) to the client device 130 over a communication network. The media player application 140 may then play the streamed video content for the user on the display screen 190.

As shown in the diagram, the media delivery system 100 may include a dynamic channel generator 120. The dynamic channel generator 120 may generate dynamic channels for users of the media delivery service that are personalized on a per-user basis. In an embodiment, the dynamic channel generator 120 generates a dynamic channel for a user based on selecting video assets to be included in the dynamic channel from a collection of video assets offered by the media delivery service and arranging the selected video assets in a particular order so that the dynamic channel feels like a linear feed. The dynamic channel generator 120 may select the video assets to be included in the dynamic channel for a user based on a user profile of the user. The user profile of the user may include information regarding the user's previous viewing history, the user's demographic, the user's location, the time of day at the user's location, etc. In an embodiment, the dynamic channel generator 120 employs machine learning techniques to select the video assets to be included in a dynamic channel for a user. For example, the dynamic channel generator 120 may select the video assets to be included in a dynamic channel for a user using machine learning models that were previously trained to predict which video assets the user will enjoy (e.g., based on the user profile of the user). The dynamic channel generator 120 may thus algorithmically generate a dynamic channel for a user to include video assets that are personalized for the user. The video assets selected to be included in a dynamic channel may be movies, TV shows, episodes of series, or any combination thereof.

The media delivery system 100 may invoke the dynamic channel generator 120 to generate a dynamic channel for a user at the time the user logs into the media delivery service, when the user accesses an EPG provided by the media delivery service, when the user chooses to watch the dynamic channel (e.g., by choosing the dynamic channel in the EPG), or at another point in time. In an embodiment, the media delivery system 100 may invoke the dynamic channel generator 120 to generate dynamic channels for users as part of an offline process or regularly scheduled job (rather than on demand).

If a user chooses to watch a dynamic channel, then the media delivery system 100 may stream the video assets included in the dynamic channel to the client device 130 in sequence so that the media player application 140 of client device 130 can play the video assets for the user as it if were a linear channel. For example, once the media player application 140 finishes playing the first video asset included in the dynamic channel, the media delivery system 100 may automatically stream the next video asset included in the dynamic channel to the client device 130 so that the media player application 140 can start playing the next video asset for the user. The other video assets included in the dynamic channel may be played in sequence in a similar manner to make the dynamic channel feel like a linear channel.

In an embodiment, the dynamic channel generator 120 generates a dynamic channel for a user based on selecting video assets to be included in the dynamic channel, on an as-needed basis. For example, if the users chooses to watch the dynamic channel, the media delivery system 100 may invoke the dynamic channel generator 120 to select a video asset to play for the user at that time and the media delivery system 100 may stream that video asset to the client device 130 so that the media player application 140 of client device 130 can play that video asset for the user. When the video asset finishes playing, the media delivery system 100 may again invoke the dynamic channel generator 120 to automatically select the next video asset to play for the user at that time and the media delivery system 100 may stream that video asset to the client device 130 so that the media player application 140 of client device 130 can play that video asset for the user.

In an embodiment, the media delivery service offers a branded dynamic channel. A branded dynamic channel may be associated with a particular brand. The branding may be provided in terms of a particular content provider, a series, and/or a theme (e.g., comedy shows of a particular content provider or comedy shows in general without necessarily being tied to a particular content provider), etc. The video assets included in a branded dynamic channel may be selected from a library of video assets associated with a particular brand. A branded dynamic channel may be available to many users of the media delivery service, but the video assets included in the branded dynamic channel or the sequence of video assets included in the branded dynamic channel may be different for different users watching the branded dynamic channel at the same time. That is, the branded dynamic channel may have the same identity or branding for multiple users of the media delivery service but be dynamically programmed/personalized on a per-user basis. For example, the media delivery service may offer a HGTV® (Home and Garden TV) branded dynamic channel to users. The HGTV® branded dynamic channel may play a different set or sequence of HGTV® shows to different users depending on the user profile's of those users. The branding allows users to have affinity and trust for the particular channel.

In an embodiment, the media delivery service allows the user to provide input on the type of video content they enjoy watching and the dynamic channel generator 120 may generate a dynamic channel for the user based on the user's input. For example, the media delivery service may ask the user to select ten TV shows/movies that the user enjoys to watch and the dynamic channel generator 120 may generate a dynamic channel for the user that includes those TV shows/movies or similar TV shows/movies.

In an embodiment, a dynamic channel includes a mix of on-demand video assets and live/prescheduled video content (e.g., a live broadcasted sporting event or premier of a TV show). For example, sections of a dynamic channel's schedule may have preprogrammed/prescheduled video content, but outside of those sections, video assets may be dynamically determined based on the user profile of the user (personalized for the user).

As shown in the diagram, the media delivery system 100 may include an EPG generator 125. The EPG generator 125 may generate information that is usable by the media player application 140 to generate an EPG GUI 160. The EPG generator may obtain information regarding linear channels offered by the media delivery service (“linear channel information”) and information regarding dynamic channels offered by the media delivery service (“dynamic channel information”). The linear channel information may include the names of the linear channels and time schedule information for the linear channels. The dynamic channel information may include the names of the dynamic channels and information regarding one or more video assets included in each dynamic channel that are needed for generating the EPG GUI 160 (e.g., the titles of the video assets, descriptions of the video assets, representative images of the video assets, the durations of the video assets, etc.). In an embodiment, the dynamic channel generator 120 generates dynamic channels for a user and provides information regarding those dynamic channels to the EPG generator 125. The EPG generator 125 may transmit the linear channel information and the dynamic channel information to the client device 130 over a communication network (e.g., the Internet). The media player application 140 of the client device 130 may use this information to generate the EPG GUI 160 or other GUIs (e.g., a playback GUI) described herein.

As shown in the diagram, the GUI 150 of media player application 140 may include an EPG GUI 160. The EPG GUI 160 may allow a user to browse and access linear channels 170 and dynamic channels 180 offered by the media delivery service. The EPG GUI 160 may display a list of channels offered by the media delivery service and allow the user to choose a channel to watch. In an embodiment, the EPG GUI 160 may list dynamic channels offered by the media delivery service alongside linear channels to make the dynamic channels feel like linear channels. However, unlike linear channels, the dynamic channels can have different video assets or different sequences of video assets for different users and, as will be further described herein, may allow users to skip video assets because, unlike linear channels, the dynamic channels need not follow a predetermined time schedule.

For linear channels, the EPG GUI 160 may display time schedule information for the linear channels. The time schedule information for a linear channel may include the start times of the video contents included in the linear channel, the end times of the video contents included in the linear channel, and/or the duration of the video contents included in the linear channel. The EPG GUI 160 may display the time schedule information textually and/or graphically (e.g., each scheduled video content may be represented as a rectangle that spans an axis representing time). The EPG GUI 160 may allow a user to browse through the list of linear channels offered by the media delivery service and choose a particular linear channel to watch. If the user chooses to watch a particular linear channel, the media player application 140 may play the currently scheduled (“live”) video content for that linear channel at that time. Notably, since the linear channel follows a predetermined time schedule, the user cannot choose to watch video content of the linear channel that is scheduled for a future time.

For dynamic channels, the EPG GUI 160 may allow the user to browse through the sequence of video assets included in the dynamic channel and choose to watch a particular video asset. Unlike linear channels, a dynamic channel does not need to follow a predetermined time schedule so the user can potentially choose to watch any of the video assets included in the dynamic channel, without being restricted by time.

The EPG GUI 160 may allow the user to access a dynamic channel in a variety of ways. In an embodiment, the EPG GUI 160 does not allow the user to browse the entire sequence of video assets included in the dynamic channel, but only allows the user to view what will play if the user chooses to watch the dynamic channel and what will play next. In an embodiment, the EPG GUI 160 only allows the user to view what will play if the user chooses to watch the dynamic channel and does not allow the user to view what will play next. In an embodiment, the EPG GUI 160 does not allow the user to view what will play if the user chooses to watch the dynamic channel (e.g., only displays the channel name). In an embodiment, the EPG GUI 160 allows the user to browse through the entire sequence of video assets included in the dynamic channel and choose a video asset to watch. In an embodiment, the EPG GUI 160 allows the user to only browse through a subset of the sequence of video assets included in the dynamic channel and choose a video asset to watch.

In an embodiment, the EPG GUI 160 displays information regarding the first video asset included in the dynamic channel and also displays a first GUI element (e.g., a “play” button) that can be activated by the user to play the first video asset. The EPG GUI 160 may further display a second GUI element (e.g., a “skip” button) that can be activated by the user to see information regarding the next video asset included in the dynamic channel. If the user activates the second GUI element, the EPG GUI 160 may display information regarding the next video asset and display a third GUI element (e.g., a “play” button) that can be activated by the user to play that video asset. In an embodiment, the EPG GUI 160 displays a graphical representation of the next video asset with the second GUI element (e.g., with the “skip” button) to provide a hint of what the next video asset is going to be. The graphical representation for the next video asset may be an image or a short animation that indicates or hints at what the next video asset is. The second GUI element may be overlaid on top of the graphical representation of the next video asset or be placed near the graphical representation of the next video asset. The EPG GUI 160 may display a fourth GUI element (e.g., a “skip” button) that can be activated by the user to see information regarding the next video asset included in the dynamic channel. In an embodiment, the EPG GUI 160 displays a GUI element (e.g., a “rewind” button) that can be activated by the user to go back and see information regarding the previous video asset in the sequence. Thus, the EPG GUI 160 may allow the user to browse through the sequence of video assets included in the dynamic channel one-by-one to see information regarding the different video assets included in the dynamic channel and may allow the user to choose a particular video asset to watch.

If the user chooses to watch a particular video asset included in the dynamic channel, then the media player application 140 may play that video asset for the user (e.g., which may involve the media player application 140 requesting the particular video asset from the media delivery system 100 and receiving a stream of the particular video asset from the media delivery system 100). In an embodiment, the GUI 150 of the media player application 140 includes a playback GUI. The media player application 140 may display a playback GUI for a video asset while the video asset is playing or otherwise loaded/loading within the media player application 140. The playback GUI for a video asset may display the current playback location within the video asset and allow the user to navigate through the video (e.g., fast forward, rewind, and/or jump to a particular playback location within the video asset). The media player application 140 may display the playback GUI for a video asset responsive to detecting user input (e.g., when the user touches the touchscreen, moves the mouse, and/or pauses the video asset). In an embodiment, the playback GUI is overlaid on top of the actual video of the video asset being played.

In an embodiment, the playback GUI for a video asset includes a GUI element (e.g., a “play” or “skip” button) that can be activated by the user to start playing the next video asset included in the dynamic channel before the current video asset has finished playing. In an embodiment, if the user activates the GUI element to start playing the next video asset, the media player application 140 records some information indicating that the user was not interested in the current video asset and provides this information to the media delivery system 100. The dynamic channel generator 120 of the media delivery system 100 may take this information into account when selecting which video assets to include in dynamic channels for the user going forward. For example, if the user chose to skip to the next video asset shortly after the current video asset started playing (e.g., within the first 5 minutes of the video asset), then the dynamic channel generator 120 may decide to select video assets that are substantially different from the current video asset to be included in dynamic channels for the user going forward (e.g., not select an episode of the same TV show but an episode of a different show).

In an embodiment, the media delivery service provides both a linear version of a channel and a dynamic version of the channel. The linear version of the channel and the dynamic version of the channel may be associated with the same brand. The dynamic version of the channel may include a sequence of video assets that are dynamically selected for the user and may allow the user to skip video assets, as described above. The linear version of the channel may follow a predetermined time schedule and thus not allow the user to skip ahead. In an embodiment, the GUI 150 of the media player application 140 allows a user watching a linear version of a channel to switch to watching the dynamic version of the channel (and vice versa). That is, the GUI 150 may allow a user to toggle between watching the linear version of the channel and the dynamic version of channel. In an embodiment, the GUI 150 allows a user watching a linear channel to “skip” the currently scheduled “live” video content (e.g., by displaying a “skip button”). If the user chooses to “skip” the currently scheduled “live” video content of the linear channel (e.g., by activating the “skip” button), then the media player application 140 may start playing the dynamic version of the channel, thus giving the illusion that the user can skip “live” video content.

Conventional linear channels are generated by stitching together a set of video assets selected by a curator/broadcaster. These linear channels are not personalized on a per-user basis and there is no ability to skip ahead of the currently playing video content because the linear channels must follow a predetermined time schedule. Some recommendation solutions may suggest what to watch next, but the suggestion is based on what is currently playing and is not fully personalized.

The dynamic channels disclosed herein can provide users with a branded, identifiable, and repeatable playback experience, where the user develops trust that what is going to be played by the dynamic channel is going to be something the user enjoys. The dynamic channels disclosed herein provide the user with a “laid back” watching experience that delivers video content that is catered/personalized for the user. Also, the dynamic channels disclosed herein allow a user to skip video assets, which is not possible with traditional linear channels.

The EPG GUI disclosed herein may list dynamic channels alongside linear channels to make the dynamic channels feel like linear channels. The EPG GUI may allow the user to access linear channels and dynamic channels offered by a media delivery service from a single GUI. The EPG GUI may allow users to browse through the sequence of video assets included in a dynamic channel and choose which video asset to watch. When a video asset included in a dynamic channel finishes playing, the next video asset included in the dynamic channel may be automatically played next, thereby making the dynamic channel feel like a linear channel. Traditional EPG GUIs that display a list of linear channels are oriented around a time schedule so they do not allow users to browse through a sequence of video assets that are not tied to a predetermined time schedule and choose which video asset to watch. The playback GUI disclosed herein may allow the user to start playing the next video asset included in the dynamic channel before the current video has finished playing. Thus, the GUIs disclosed herein provide a “laid back” watching experience where the user does not need to actively choose what to watch, while still providing the user with flexibility to choose to watch something else if they like. The dynamic channels are personalized for the user, which may further help reduce the amount of time that the user consumes browsing through the catalog trying to find a video asset to watch.

While a certain arrangement of components are shown in the diagram, it should be appreciated that such arrangement is provided by way of example and is not intended to be limiting. Other embodiments may implement the same/similar functionality using a different set of components and/or a different arrangement of components. Also, while some functionality is described herein as being implemented on the server side (e.g., by the media delivery system 100) and some functionality is described herein as being implemented on the client side (e.g., by the client device 30), it should be appreciated that the functionality can distributed among the server side and client side in a different manner than described herein.

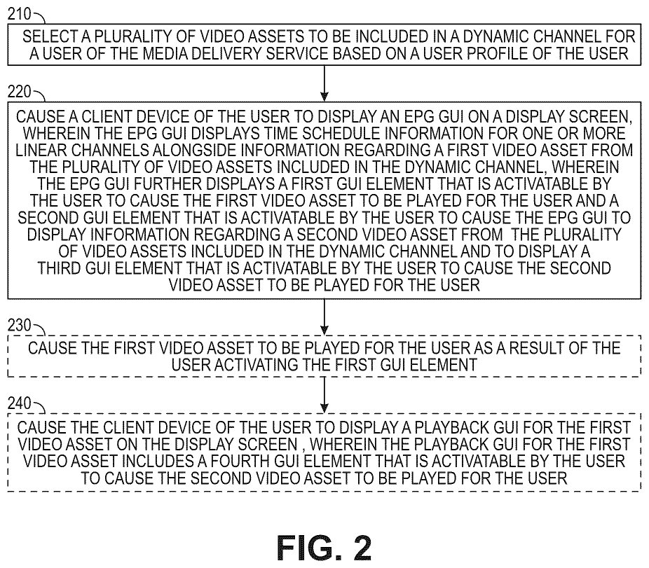

FIG. 2 is a flow diagram of a method for providing an EPG GUI, according to some embodiments. The method may be performed by a media delivery system providing a media delivery service. The media delivery system may include one or more computing devices working in coordination with each other to provide the media delivery service.

The operations in the flow diagrams will be described with reference to the exemplary embodiments of the other figures. However, it should be appreciated that the operations of the flow diagrams can be performed by embodiments of the invention other than those discussed with reference to the other figures, and the embodiments of the invention discussed with reference to these other figures can perform operations different than those discussed with reference to the flow diagrams.

At operation 210, the media delivery system selects a plurality of video assets to be included in a dynamic channel for a user of the media delivery service based on a user profile of the user. In an embodiment, the user profile of the user includes information regarding one or more of: the user's previous viewing history, the user's demographic, the user's current location, a current time at the user's current location, and the user's feedback regarding the user's favorite video content. In an embodiment, the plurality of video assets included in the dynamic channel is selected to be included in the dynamic channel when the user logs in to the media delivery service or when the user accesses an EPG provided by the media delivery service.

At operation 220, the media delivery system causes a client device of the user to display an EPG GUI on a display screen, wherein the EPG GUI displays time schedule information for one or more linear channels alongside information regarding a first video asset from the plurality of video assets included in the dynamic channel, wherein the EPG GUI further displays a first GUI element that is activatable by the user to cause the first video asset to be played for the user and a second GUI element that is activatable by the user to cause the EPG GUI to display information regarding a second video asset from the plurality of video assets included in the dynamic channel and to display a third GUI element that is activatable by the user to cause the second video asset to be played for the user. In an embodiment, the EPG GUI further displays a representative image of the second video asset with the second GUI element. In an embodiment, the one or more linear channels follow a predetermined time schedule of video contents and the dynamic channel does not follow a predetermined time schedule. In an embodiment, the time schedule information for the one or more linear channels includes information regarding start times of video contents of the one or more linear channels. IN an embodiment, the information regarding the first video asset includes a representative image of the first video asset, a title of the first video asset, and a textual description of the first video asset. In an embodiment, the second GUI element, when activated by the user, causes the EPG GUI to further display a fourth GUI element that is activatable by the user to cause the EPG GUI to display information regarding a third video asset from the plurality of video assets included in the dynamic channel. In an embodiment, the causing the client device of the user to display the EPG GUI on the display screen comprises: transmitting the time schedule information for one or more linear channels and the information regarding a first video asset to the client device of the user over a communication network.

In an embodiment, the dynamic channel is a branded dynamic channel and the plurality of video assets included in the dynamic channel is selected from a library of video assets associated with a brand of the branded dynamic channel. In an embodiment, the branded dynamic channel is also made available to other users of the media delivery service, wherein different sequences of video assets are selected to be included in the branded dynamic channel for different users of the media delivery service. In an embodiment, the one or more linear channels include a linear version of the branded dynamic channel.

In an embodiment, at operation 230, the media delivery system causes the first video asset to be played for the user as a result of the user activating the first GUI element.

In an embodiment, at operation 240, the media delivery system causes the client device of the user to display a playback GUI for the first video asset on the display screen, wherein the playback GUI for the first video asset includes a fourth GUI element that is activatable by the user to cause the second video asset to be played for the user.

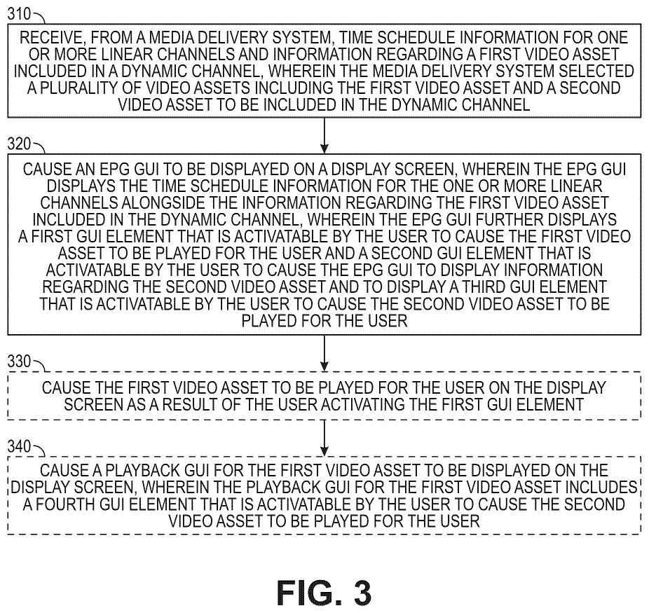

FIG. 3 is a flow diagram of a method for providing an EPG GUI, according to some embodiments. The method may be a client device that is communicatively coupled to a media delivery system providing a media delivery service.

At operation 310, the client device receives, from a media delivery system, time schedule information for one or more linear channels and information regarding a first video asset included in a dynamic channel, wherein the media delivery system selected a plurality of video assets including the first video asset and a second video asset to be included in the dynamic channel.

At operation 320, the client device causes an EPG GUI to be displayed on a display screen, wherein the EPG GUI displays the time schedule information for the one or more linear channels alongside the information regarding the first video asset included in the dynamic channel, wherein the EPG GUI further displays a first GUI element that is activatable by the user to cause the first video asset to be played for the user and a second GUI element that is activatable by the user to cause the EPG GUI to display information regarding the second video asset and to display a third GUI element that is activatable by the user to cause the second video asset to be played for the user. In an embodiment, the EPG GUI further displays a representative image of the second video asset with the second GUI element. In an embodiment, the one or more linear channels follow a predetermined time schedule of video contents and the dynamic channel does not follow a predetermined time schedule. In an embodiment, the time schedule information for the one or more linear channels includes information regarding start times of video contents of the one or more linear channels. In an embodiment, the information regarding the first video asset includes a representative image of the first video asset, a title of the first video asset, and a textual description of the first video asset. In an embodiment, the second GUI element, when activated by the user, causes the EPG GUI to further display a fourth GUI element that is activatable by the user to cause the EPG GUI to display information regarding a third video asset from the plurality of video assets included in the dynamic channel.

In an embodiment, the dynamic channel is a branded dynamic channel and the plurality of video assets included in the dynamic channel is selected from a library of video assets associated with a brand of the branded dynamic channel. In an embodiment, the branded dynamic channel is also made available to other users of the media delivery service, wherein different sequences of video assets are selected to be included in the branded dynamic channel for different users of the media delivery service. In an embodiment, the one or more linear channels include a linear version of the branded dynamic channel.

In an embodiment, at operation 330, the client device causes the first video asset to be played for the user on the display screen as a result of the user activating the first GUI element.

In an embodiment, at operation 340, the client device causes a playback GUI for the first video asset to be displayed on the display screen, wherein the playback GUI for the first video asset includes a fourth GUI element that is activatable by the user to cause the second video asset to be played for the user.

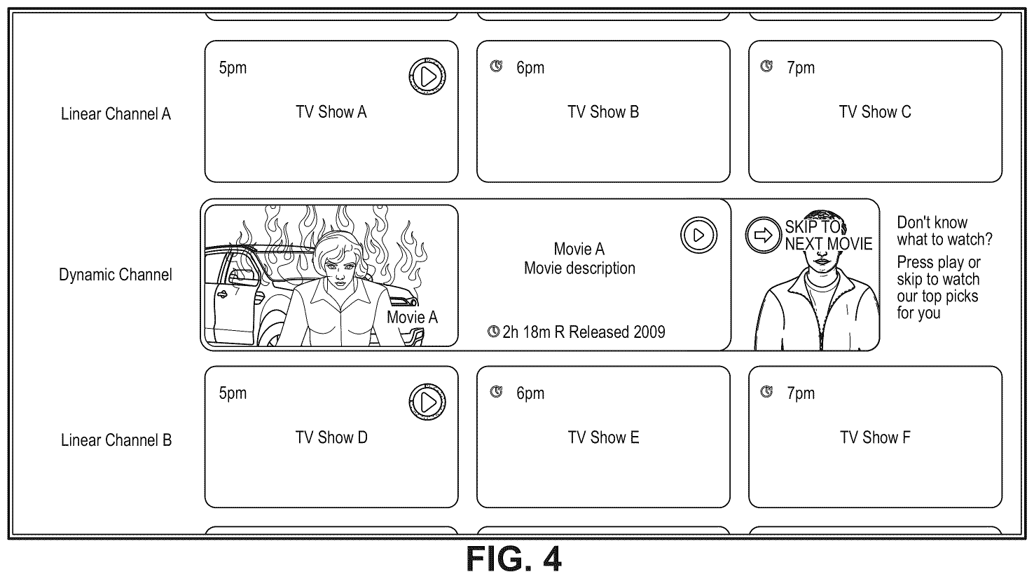

A few examples of EPG GUIs are shown in FIGS. 4-11 and described in relation thereto below.

FIG. 4 is a diagram showing an EPG GUI, according to some embodiments. As shown in the diagram, the EPG GUI may display a list of channels including linear channel A, linear channel B, and a dynamic channel. The EPG GUI may display time schedule information for the linear channels. For example, the EPG GUI may display the starting times of the TV shows that are scheduled for the linear channels (e.g., “5 pm,” “6 pm,” and “7 pm”). The EPG GUI may also display “play” buttons that can be activated by the user to play the currently scheduled TV shows for the linear channels. The EPG GUI may also display a progress bar/ring for the currently scheduled “live” video contents of the linear channels (e.g., for “TV Show A” and “TV Show D”) showing the current live progress within the video contents (e.g., in the example shown in the diagram, the progress bars/rings show around 75% progress has been made).

The EPG GUI may also display information regarding a first movie (“Movie A”) included in the dynamic channel (e.g., the title of the movie, a textual description of the movie, and a graphical representation of the movie, etc.). The EPG GUI may further display a “play” button that can be activated by the user to play the first movie. The EPG GUI may further display a graphical representation of a second movie included in the dynamic channel and a “skip” button that can be activated by the user to cause the EPG GUI to display information regarding the second movie and to display a “play” button that can be activated by the user to play the second movie. Thus, the EPG GUI may allow the user to scroll through the movies included in the dynamic channel one-by-one, see detailed information regarding each movie, and choose to watch the movie, if desired. The EPG GUI may list the dynamic channel alongside the linear channels, making the dynamic channel feel like a linear channel. However, unlike the linear channels, the dynamic channel is personalized for the user and need not follow a predetermined time schedule. Notably, for the dynamic channel, the EPG GUI allows the user to play a different movie if the user does not want to watch the first movie. Such skipping is not possible for the linear channels due to the linear channels having to follow a predetermined time schedule (e.g., the user cannot choose to watch TV show B or TV show C of linear channel A because those are scheduled for future times).

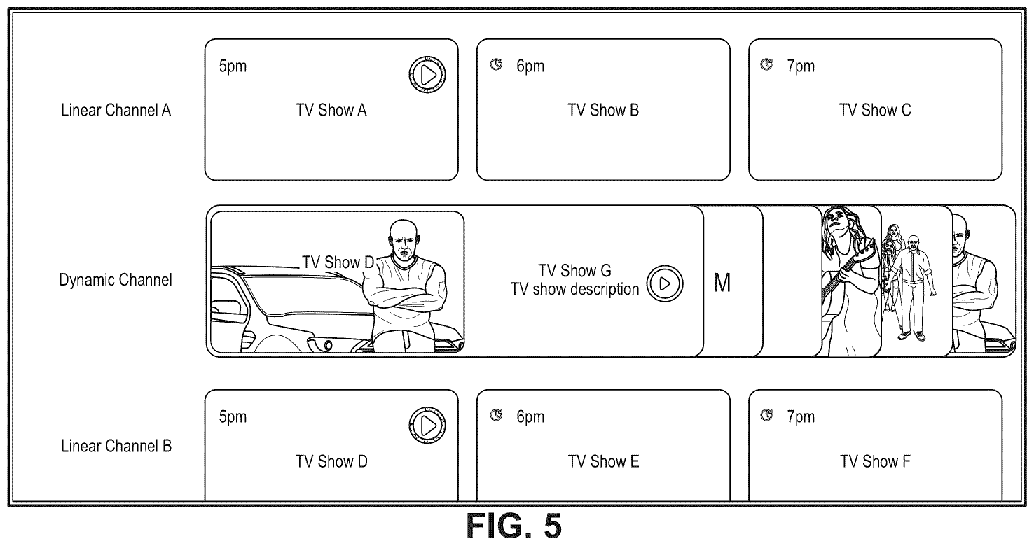

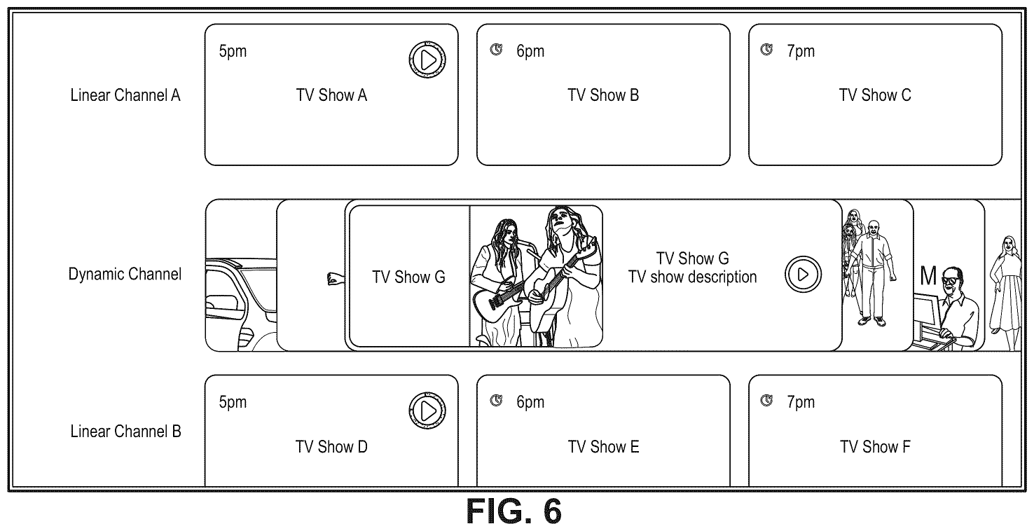

FIG. 5 is a diagram showing another EPG GUI, according to some embodiments. Similar to the EPG GUI shown in FIG. 4, the EPG GUI displays a list of channels including linear channel A, linear channel B, and a dynamic channel. Also, the EPG GUI may display “cards” for the TV shows included in the dynamic channel. Each card may include information regarding the corresponding TV show (e.g., the title of the TV show, a textual description of the TV show, and a graphical representation of the TV show, etc.) and a “play” button that can be activated by the user to play that TV show. In the example shown in the diagram, the card for the first TV show (“TV Show G”) is shown in full, while the cards for the other TV shows included in the dynamic channel are partially hidden. The EPG GUI may allow the user to scroll through the cards (e.g., by swiping on a touchscreen or clicking an arrow button on a remote control) to reveal detailed information regarding the corresponding TV shows of the other cards. For example, FIG. 6 is a diagram showing the state of the EPG GUI after the user has scrolled ahead to see another card of the dynamic channel.

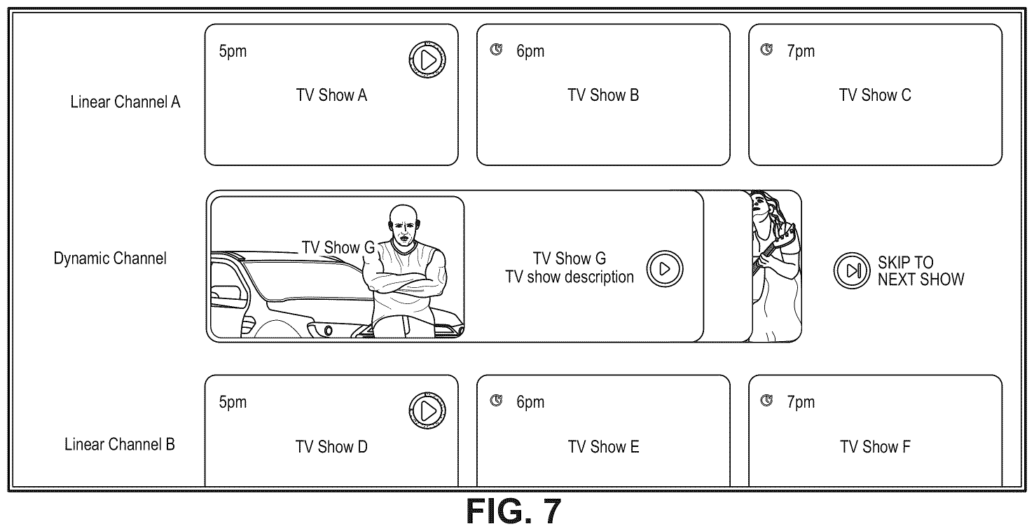

FIG. 7 is a diagram showing another EPG GUI, according to some embodiments. Similar to the EPG GUI shown in FIG. 4, the EPG GUI displays a list of channels including linear channel A, linear channel B, and a dynamic channel. Also, the EPG GUI may display “cards” for the TV shows included in the dynamic channel. Each card may include information regarding the corresponding TV show (e.g., the title of the TV show, a textual description of the TV show, and a graphical representation of the TV show, etc.) and a “play” button that can be activated by the user to play that TV show. In the example shown in the diagram, the card for the first TV show (“TV Show G”) is shown in full, while the cards for the other TV shows included in the dynamic channel are partially hidden. The EPG GUI may include a “skip” button that can be activated by the user to reveal the next card of the dynamic channel.

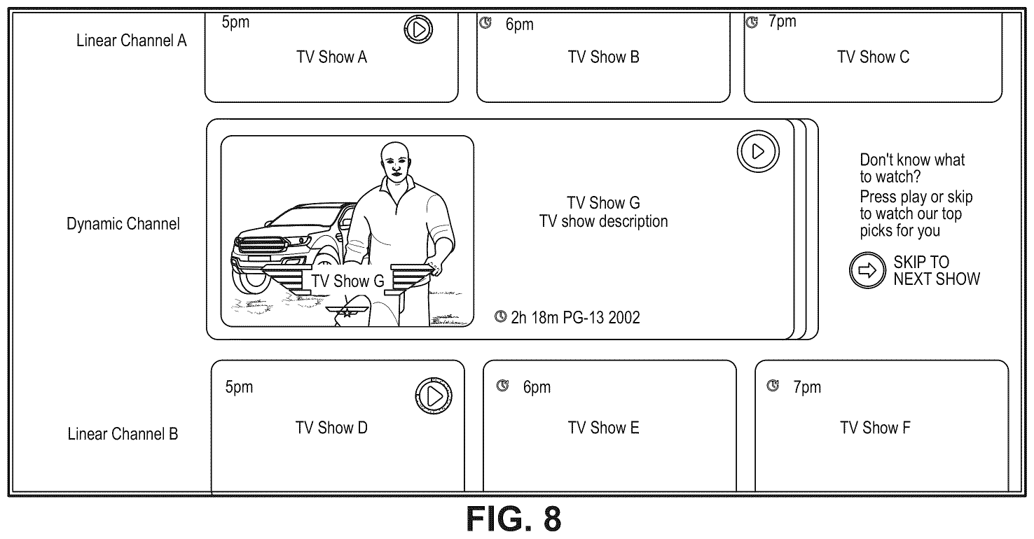

FIG. 8 is a diagram showing another EPG GUI, according to some embodiments. Similar to the EPG GUI shown in FIG. 4, the EPG GUI displays a list of channels including linear channel A, linear channel B, and a dynamic channel. Also, the EPG GUI may display “cards” for the TV shows included in the dynamic channel. Each card may include information regarding the corresponding TV show (e.g., the title of the TV show, a textual description of the TV show, and a graphical representation of the TV show, etc.) and a “play” button that can be activated by the user to play that TV show. In the example shown in the diagram, the card for the first TV show (“TV Show G”) is shown in full, while the cards for the other TV shows included in the dynamic channel are mostly hidden (the EPG GUI indicates that the cards exist but does not display any information contained in those cards). The EPG GUI may include a “skip” button that can be activated by the user to reveal the next card of the dynamic channel.

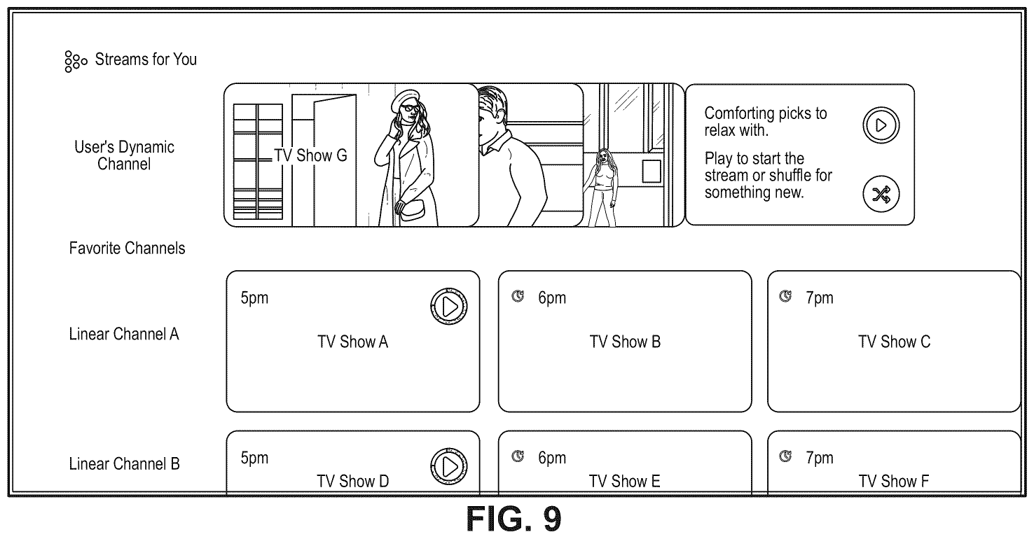

FIG. 9 is a diagram showing another EPG GUI, according to some embodiments. As shown in the diagram, the EPG GUI may display a list of channels including linear channel A, linear channel B, and a dynamic channel. The dynamic channel may be listed under a separate heading indicating that the channel is dynamic (e.g., “Streams for You”). The EPG GUI may display time schedule information for the linear channels (listed under the heading “Favorite channels”). For example, the EPG GUI may display the starting times of the TV shows that are scheduled for the linear channels. The EPG GUI may also display “play” buttons that can be activated by the user to play the currently scheduled TV shows for the linear channels.

The EPG GUI may also display a graphical representation of a first TV show (“TV Show G”) included in the dynamic channel. The EPG GUI may further display graphical representations of other TV shows that are included in the dynamic channel, but these graphical representations may be partially hidden. The EPG GUI may further display a “play” button that can be activated by the user to play the first movie and a “shuffle” button that can be activated by the user to play a different TV show included in dynamic channel (e.g., the next TV show in the sequence or a random TV show).

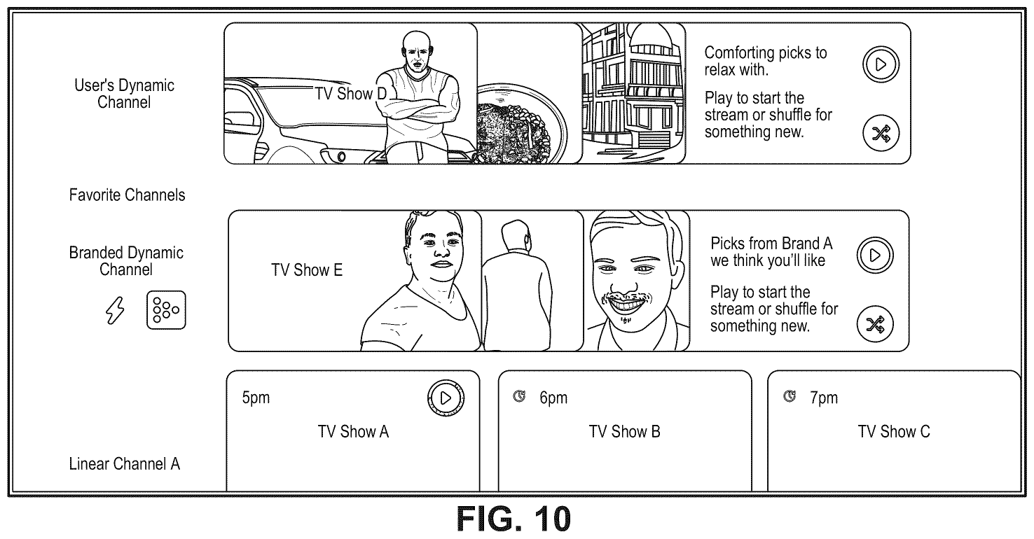

FIG. 10 is a diagram showing another EPG GUI, according to some embodiments. As shown in the diagram, the EPG GUI may display a list of channels including a user's dynamic channel, a branded dynamic channel, and linear channel A. The user's dynamic channel may be a dynamic channel that includes video assets selected for the user from across multiple video asset libraries (e.g., all video asset libraries accessible to the media delivery service). In contrast, the branded dynamic channel may be a dynamic channel that only includes video assets selected for the user from a particular video asset library associated with a particular brand. The EPG GUI may display time schedule information for linear channel A. For example, the EPG GUI may display the starting times of the TV shows that are scheduled for linear channel A. The EPG GUI may also display a “play” button that can be activated by the user to play the currently scheduled TV show (“TV Show A”) for linear channel A.

As shown in the diagram, the EPG GUI may also display a graphical representation of a first TV show (“TV Show D”) included in the user's dynamic channel. The EPG GUI may further display graphical representations of other TV shows that are included in the user's dynamic channel, but these graphical representations may be partially hidden. The EPG GUI may further display a “play” button that can be activated by the user to play the first TV show included in the user's dynamic channel and a “shuffle” button that can be activated by the user to play a different TV show included in the user's dynamic channel (e.g., the next TV show in the sequence or a random TV show included in the user's dynamic channel).

Also, as shown in the diagram, the EPG GUI may display a graphical representation of a first TV show (“TV Show E”) included in the branded dynamic channel. The EPG GUI may further display graphical representations of other TV shows that are included in the branded dynamic channel, but these graphical representations may be partially hidden. The EPG GUI may further display a “play” button that can be activated by the user to play the first TV show included in the branded dynamic channel and a “shuffle” button that can be activated by the user to play a different TV show included in the branded dynamic channel (e.g., the next TV show in the sequence or a random TV show included in the branded dynamic channel).

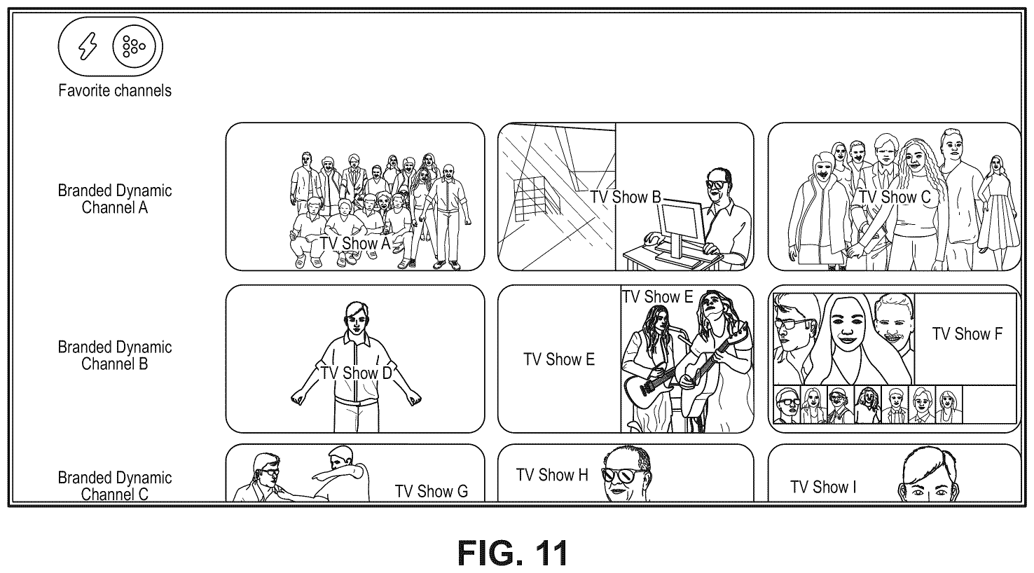

FIG. 11 is a diagram showing another EPG GUI, according to some embodiments.

As shown in the diagram, the EPG GUI may display a list of branded dynamic channels including branded dynamic channel A, branded dynamic channel B, and branded dynamic channel C. Each branded dynamic channel may be a dynamic channel that only includes video assets selected for the user from a particular video asset library associated with a particular brand. The EPG GUI may display graphical representations of the TV shows included in each dynamic channel. The graphical representations may be activated by a user to play the corresponding TV show. Also, as shown in the diagram, the EPG GUI may include a toggle switch that can be activated by the user to toggle the EPG GUI between dynamic channel mode (represented by the “play” icon) and linear channel mode (represented by the “lightning” icon). In the dynamic channel mode, the EPG GUI may only display a list of dynamic channels. In the linear channel mode, the EPG GUI may only display a list of linear channels.

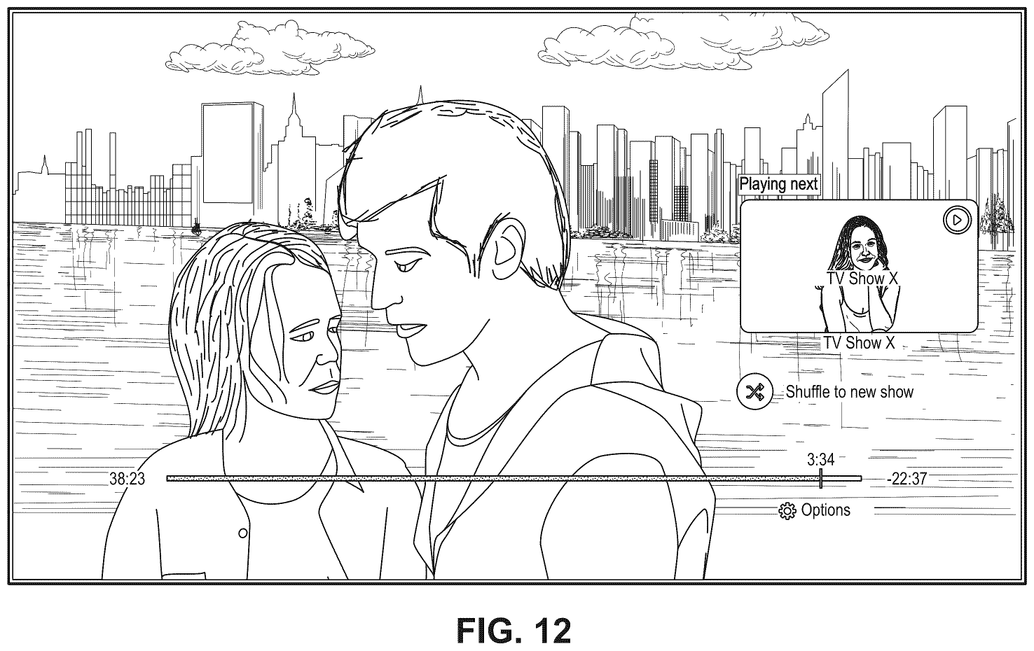

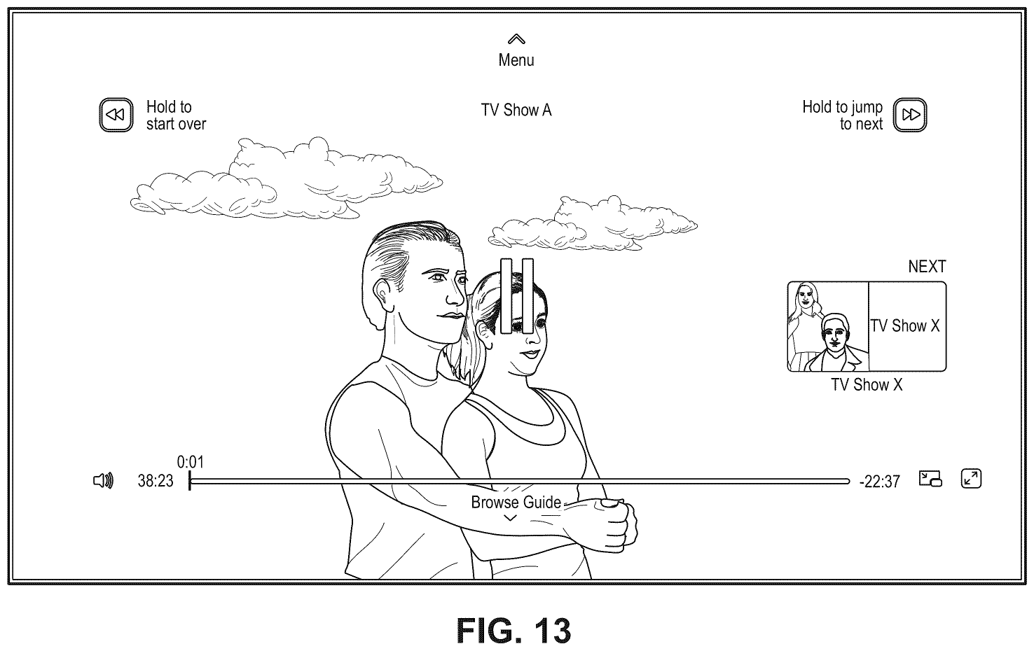

A few example playback GUIs are shown in FIGS. 12 and 13 and described in relation thereto below.

FIG. 12 is a diagram showing a playback GUI, according to some embodiments.

The playback GUI may be displayed while the user is watching a TV show included in a dynamic channel. The playback GUI may be overlaid on top of the actual video of the TV show. As shown in the diagram, the playback GUI may display a scrubber bar that shows the current playback location in the current TV show and that allows a user to navigate through the currently TV show (e.g., jump to a particular playback location within the TV show). Also, the playback GUI may display a graphical representation of the next TV show (“TV Show X”) included in the dynamic channel (as a preview of what is coming up next) and a “play” button that can be activated by the user to immediately play the next TV show (without having to wait until the current video asset finishes playing). Notably, the next TV show was dynamically selected by the media delivery system for the user, and is not part of a schedule that is predetermined by a curator/broadcaster. The playback GUI may further display a “shuffle” button that can be activated by the user to play a different TV show included in the dynamic channel (e.g., a TV show that is different from “TV Show X”).

FIG. 13 is a diagram showing another playback GUI, according to some embodiments.

The playback GUI may be displayed while the user is watching a TV show included in a dynamic channel. The playback GUI may be overlaid on top of the actual video of the TV show. As shown in the diagram, the playback GUI may display the title of the current TV show (“TV Show A”) and a scrubber bar that shows the current playback location in the current TV show and that allows a user to navigate through the current TV show (e.g., jump to a particular playback location within the TV show). Also, the playback GUI may display a graphical representation of the next TV show (“TV Show X”) included in the dynamic channel (as a preview of what is coming up next). Notably, the next TV show was dynamically selected by the media delivery system for the user, and is not part of a schedule that is predetermined by a curator/broadcaster. The playback GUI may also include a “left arrow” button that can be activated by the user to start playing the current TV show from the beginning (to “start over”) and a “right arrow” button that can be activated by the user to immediately play the next video included in the dynamic channel (without having to wait until the current video asset finishes playing). The user may activate the “left arrow” button displayed in the playback GUI by holding down the left arrow button on a remote control or keyboard. The user may activate the “right arrow” button displayed in the playback GUI by holding down the left arrow button on a remote control or keyboard.

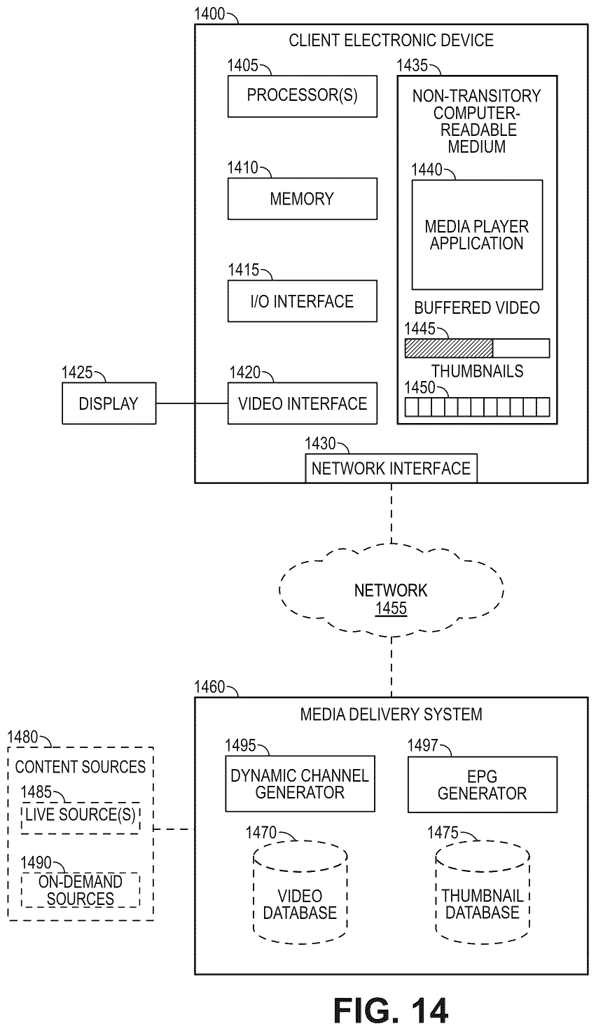

FIG. 14 is a block diagram showing a video streaming system, according to some embodiments. The system includes a client electronic device 1400 that is communicatively coupled to a media delivery system 1460 over a network 1455. In an embodiment, a client electronic device 1400 (also referred to as a client device) is an electronic device that is able to request video content (also referred to simply as “video”) from the media delivery system 1460 and to play video content served by the media delivery system 1460. The media delivery system 1460 is a system configured to receive requests for video content from the client electronic device 1400 and to serve the requested video content to the client electronic device 1400. Although one client electronic device 1400 is shown in FIG. 14, the system can include more than one such client electronic device 1400 and typically may include many separate client electronic devices 1400. Furthermore, the media delivery system 1460 can include additional components such as processors, storage servers, authentication servers, firewalls, and load balancers, which are not shown here for sake of clarity.

As shown in the diagram, the client electronic device 1400 includes one or more processors 1405, a memory 1410, an input/output (I/O) interface 1415, a video interface 1420, a network interface 1415, and a non-transitory computer-readable medium 1435. The processors 1405 may be, for example, general purpose microprocessors. The memory 1410 may be a Random Access Memory (RAM) or other dynamic or volatile storage device for storing data and instructions to be executed by the processors 1405. Memory 1410 may also be used for storing temporary variables or other intermediate information during execution of instructions to be executed by the processors 1405. Such instructions, when stored in the non-transitory computer-readable medium 1435, render client electronic device 1400 to be a special-purpose machine that is customized to perform the operations specified by the instructions.

Media player application 140 may be an application that allows users to browse and play video accessible from a media delivery system 460. In one embodiment, the non-transitory computer-readable medium 1435 includes a GUI module that is included as part of a media player application 140. The GUI module may provide one or more GUIs (e.g., EPG GUI and/or playback GUI) described herein.

The I/O interface 1415 is configured to receive user input via an input device. The input device may be any type of device that can receive user input such as a keyboard, a mouse, a touchscreen panel affixed to a display, a trackpad, or a remote control. Other examples of suitable input devices include cameras, microphones, accelerometers, motion detectors, brain-machine interfaces, and/or other sensors.

The video interface 1420 is communicatively coupled to a display screen 1425 (also referred to as a display) and is configured to output video content to the display 1425. The display 1425 may be any type of device that can display video content, the possible types of displays including, but not limited to, a television, a computer monitor, or a touchscreen display. While the display 1425 is shown as being separate from the client electronic device 1400, in some embodiments, the display 1425 is integrated with the client electronic device 1400.

The client electronic device 1400 may be any type of device that can request and receive video content and can output video content to a display 1425. For example, a client electronic device 1400 can comprise a mobile device, a tablet computer, a desktop computer, a set-top box (STB), a smart TV, a video game console, a digital media player, a digital versatile disk (DVD) player, or a Blu-Ray player.

The data/communication network 1455 can be any type of network capable of transporting data from one device to another device (for example, from a client electronic device 1400 to media delivery system 1460 and from media delivery system 1460 to one or more client electronic devices 1400). For example, the data/communication network 1455 can include any combination of the Internet, a Wide Area Network (WAN), a Local Area Network (LAN), a cellular communications network, a telephone network, a terrestrial analog or digital signal system, a cable system, and a satellite communications system.

The media delivery system 1460 includes a video database 1470 and a thumbnail database 1475 (e.g., each of which can be a file system, key value store, relational database, or any other suitable storage means). In an embodiment, the media delivery system 1460 can be implemented across any number of hardware devices and platforms in a distributed manner. In an embodiment, the media delivery system 1460 ingests video content from content sources 1480, such as one or more live content source(s) 1485 (for example, live linear programming from one or more broadcast sources), one or more on demand content sources 1490 (for example, one or more video-on-demand (VOD) content services), or both, and stores some or all of the ingested video content in the video database 1470 to be served to client electronic devices 1400. The media delivery system 1460 may store thumbnails for some or all of the ingested video content in the thumbnail database 1475. For example, video content items (for example, television episodes, movies, VOD programs, and so forth) stored in the video database 1470 may be associated with corresponding sets of thumbnails. In an embodiment, the set of thumbnails associated with a video content item can include thumbnails where each thumbnail is associated with a particular time position in the video content. For example, the set of thumbnails for a particular video content item might include a thumbnail for every five (5) second increment in the video content. More granular or less granular thumbnail increments are also possible. In one embodiment, the media delivery system 1460 includes a dynamic channel generator 1495 that can implement functionality of the dynamic channel generator 120 described herein above. In one embodiment, the media delivery system 1460 includes an EPG generator 1497 that can implement functionality of the EPG generator 125 described herein above. The dynamic channel generator 1495 and the EPG generator 1497 may be implemented using software, hardware, firmware, or any combination thereof.

In an embodiment, certain components of the media delivery system 1460 can be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities on behalf of another entity for whom the components are deployed. In other embodiments, the described systems may be implemented entirely by computer systems owned and operated by a single entity.

During operation of the system, a client electronic device 1400 may generate and transmit one or more requests to the media delivery system 1460 to play or otherwise access particular video content items. In response to receiving such requests, the media delivery system 1460 may serve the requested video content items to the client electronic devices 1400. This may involve transmitting/streaming video content stored in the video database 1470, as well as thumbnails associated with the video content stored in the thumbnail database 1475, to the client electronic devices 1400 over the network 1455. The client electronic devices 1400 may buffer a portion of the received video content (e.g., buffered video 1445) in the non-transitory machine-readable medium 435 and output the buffered video content to the display 1425. In one embodiment, the client device 1400 buffers a threshold amount of video content following (and preceding) the user's current viewing position in the video (e.g., buffered video 1445). The client electronic device 1400 may also store some or all of the thumbnails 1450 for the video content in the non-transitory machine-readable medium 1435. Each thumbnail is associated with a time position in the video. The client device 1400 may use the thumbnails 1450 to generate and output (to the display 1425) a GUI that allows a user to navigate through a video.

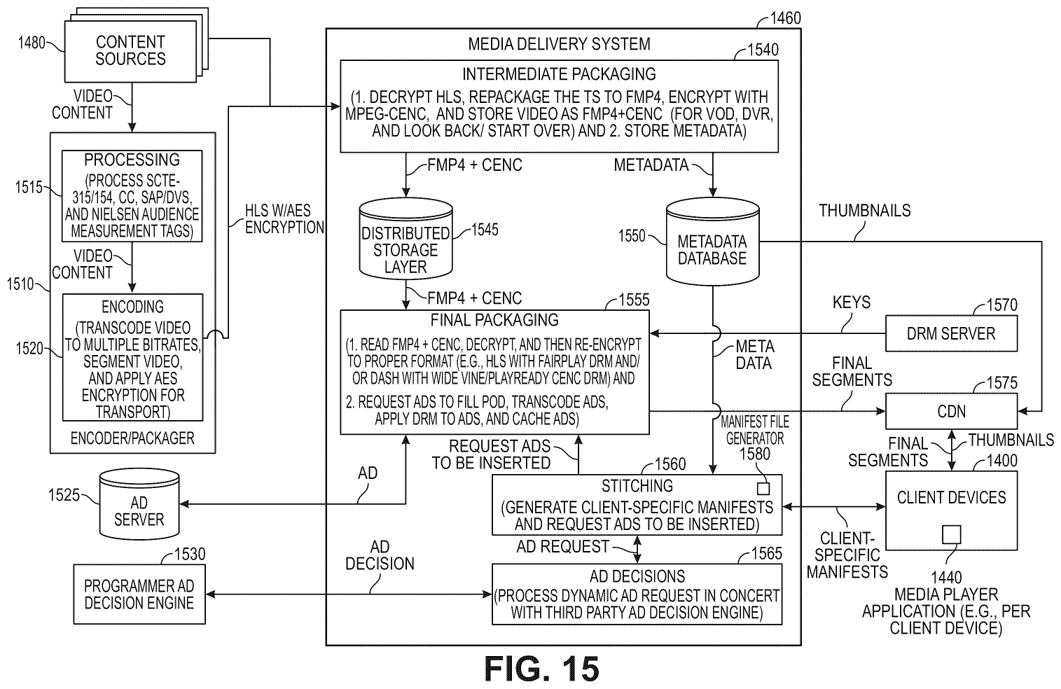

FIG. 15 is a diagram showing a video streaming system architecture, according to some embodiments. In an embodiment, the system of FIG. 15 includes content sources 1480, an encoder/packager 1510, a media delivery system 1460, an ad server 1525, a programmer ad decision engine 1530, a Digital Rights Management (DRM) server 1570, a Content Distribution Network (CDN) 1575, and client electronic devices 1400. The encoder/packager 1510 includes a processing component 1515 and an encoding component 1520. The media delivery system 1460 includes an intermediate packaging component 1540, a final packaging component 1555, a stitching component 1560, and an ad decisions component 1565.

The content sources 1480 provide video content that is to be consumed by users. The video content can include live content, VOD content, and/or any other type of video content.

The encoder/packager 1510 ingests video content from the content sources 1480. For example, the encoder/packager 1510 can ingest live video content picked up from a signal of a live linear cable network-national or local, where appropriate and agreed upon. As another example, the encoder/packager 1510 can ingest VOD content directly from the programmer itself or via a content aggregation partner. In one embodiment, the encoder/packager 1510 may ingest video content via satellite or terrestrial means. In one embodiment, the encoder/packager 1510 receives Society of Cable and Telecommunications Engineers 35 2013 (SCTE-35) markers in a data Program Information Description (PID) along with the video content. SCTE-35 can be used to signal ad insertion opportunities in the transport stream, which can be used for Dynamic Ad Insertion (DAI). In one embodiment, the encoder/packager 1510 receives Nielsen audience measurement tags in a data PID, or embedded in the audio stream. The Nielsen audience measurement tags can be used to measure audience size and demographic information. The processing component 1515 of the encoder/packager 1510 processes the SCTE-35 markers and the Nielsen audience measurement tags as well as any Closed Captioning (CC) and Second Audio Programming (SAP)/Descriptive Video Service (DVS) information.

In one embodiment, the encoding component 1520 of the encoder/packager 1510 transcodes the video content into multiple bitrates (for example, into several Adaptive Bitrate (ABR) profiles) and places key frames at ad boundaries as informed by the SCTE-35 data. The packager segments the content according to the keyframes placed by the transcoder and encrypts the content for transport (for example, using Advanced Encryption Standard (AES) encryption). In one embodiment, the video is packaged using the Hypertext Transfer Protocol (HTTP) Live Streaming (HLS) protocol with AES encryption and the HLS-encoded video is provided to the media delivery system 1460 (for example, over a private network connection).

In one embodiment, the intermediate packaging component 1540 of the media delivery system 1460 decrypts the received video content, repackages the video content to an intermediate format (for example, using fragmented MPEG-4 (fMP4) or any other video streaming format), encrypts the repackaged video (for example, using MPEG Common Encryption (MPEG-CENC)), and stores the encrypted video segments in a distributed storage layer 1545, which serves as the origin for the content distribution network (CDN). In general, the intermediate packaging component 1540 can repackage and store the video in any intermediate file format suitable for transfer to a CDN, directly to client devices 1400, or both. In one embodiment, to provide low-latency access to live content, the media delivery system 1460 can act as a fall back origin for the CDN in case the video segments are requested before they have been permanently stored in the distributed storage layer 1545. When a client electronic device 1400 requests a video, the video segments can be repackaged on the fly (just-in-time repackaging) into the appropriate output format. In other embodiments, the video content ingested from content sources 1480 can be stored in its original format (e.g., HLS) without conversion.

In one embodiment, the distributed storage layer 1545 is provided using a cloud-based storage service. Also, the intermediate packaging component 1540 may store relevant metadata for the video (for example, timestamps and SCTE-35 markers) in a metadata database 1550 (for example, a relational database or other data storage application). In one embodiment, the metadata includes some or all of: information related to ad positions, ad insertion information, information related to thumbnail image files such as their associated time positions in the video (the thumbnails themselves may be stored in distributed storage layer 1545—for example, stored in JPG or PNG format), and user-generated content (e.g., annotations and/or comments). In an embodiment, metadata database stores timed metadata. For live video, the metadata may include GIF preview animations showing the most recent video (the most recent 15 seconds, for example). In one embodiment, the thumbnails are cached in one or more Content Distribution Networks (CDNs) to be served to clients.

In one embodiment, the media delivery system 1460 ingests mezzanine VOD assets from a programmer via a secure Internet Protocol (IP) connection. The VOD assets may then be processed using a job-based workflow. In one embodiment, the metadata for the VOD assets are ingested and stored in the metadata database 1550 while the mezzanine files are transcoded to fMP4 with CENC and stored in the distributed storage layer 1545.

The final packaging component 1555 of the media delivery system 1460 reads the encrypted video segments, decrypts the segments, optionally repackages the segments, and then re-encrypts the segments to the proper format. In one embodiment, the re-encrypted formats include HLS with FairPlay Digital Rights Management (DRM), Dynamic Adaptive Streaming over HTTP (DASH) with Wide Vine/PlayReady CENC DRM, or both. The final packaging component 1555 passes through any ID3 tags for Nielsen measurements and communicates with the DRM server 1570 (which manages content license keys) to ensure that all content is encrypted with up-to-date keys. The final video segments are cached in one or more CDNs 1575 to be served to client electronic devices 400.

The stitching component 1560 of the media delivery system 1460 generates client-specific manifests on the fly (just-in-time manifest creation to allow for fine-grained control over the video stream and the end-user experience—for example, just-in-time manifest creation may allow for performing DAI that is personalized for the end-user and/or for tweaking the start/end time of a show (e.g., when recording a live event, it may not be possible to know exactly when the show starts-if a human marks when the show starts, this information can be dynamically added to the manifest)). The stitching component 1560 can generate manifests for HLS, DASH, or any manifest format suitable for the client electronic devices 1400. The manifests may be generated based on the metadata stored in the metadata database 1550. In one embodiment, the stitching component 1560 includes a manifest file generator 1580 to generate manifest files. In other embodiments, the manifest file generator 1580 may be separate from the stitching component 1560. Also, the stitching component 1560 may drive DAI using a programmer ad decision engine 1530. For example, the stitching component 1560 may send a request to the ad decisions component 1565 for ads to be dynamically inserted into a video. The ad decisions component 1565 processes the dynamic ad request in concert with a third-party ad decision engine such as the programmer ad decision engine 1530 and provides an indication of the ads to be inserted into the video. The stitching component 1560 may then make a request to the final packaging component 1555 to insert the ads. When a client ad pod is upcoming, the final packaging component 1555 of the media delivery system 1460 may request the ads from the ad server 1525 to fill the ad pod, transcode the ads, apply DRM to the ads (because some platforms cannot play encrypted content followed by unencrypted content), and cache the ads (e.g., if the ads have not already been stored/cached). The stitching component 1560 may check the metadata database 1550 to determine whether the ads have been ingested. If the ads have been ingested, the stitching component 1560 may insert the metadata for the ads into the manifest. If the ads have not been ingested, then the stitching component 1560 may ask another component/system to do so. The stitching component 1560 serves the manifest that refers to the freshly transcoded ad pod video segments.

In an embodiment, client electronic devices 1400 include a media player application (for example, a media player application 140) capable of playing streaming video (for example, video content in HLS with FairPlay format or DASH with Wide Vine/CENC format). When the user selects a video to watch, the client electronic device 1400 requests a manifest for the selected video (e.g., a streaming manifest file) from the stitching component 1560. In one embodiment, this request is made over HTTP Secure (HTTPS). If the user is not currently streaming more concurrent streams than they are allowed (for example, as determined by the stitching component 1560 or another component of the media delivery system 1460), then the stitching component 1560 generates a manifest that is specific for the client electronic device 1400 and sends the manifest to the client electronic device 1400. The client electronic device 1400 may then begin fetching encrypted video segments from the CDN 1575 according to the manifest. In one embodiment, the encrypted video segments are fetched from the CDN 575 over HTTPS. The content can be fetched from the CDN 575 over a public network such as the internet and thus may travel across a variety of networks. In one embodiment, the client electronic device 1400 may cause a EPG GUI and/or playback GUI to be displayed on a display screen, as described herein.

The media delivery system 1460 shown in FIG. 15 may report audience measurement data to Nielsen (or other entities that gather audience measurement data) based on metadata embedded in the video segments. Client electronic devices 1400 may have access to a Nielsen Software Development Kit (SDK) library that enables the client electronic devices 1400 to report audience measurement data or other software to implement similar functionality.

In one embodiment, the media delivery system 1460 shown in FIG. 15 supports the ability to enforce content viewing rules and restrictions according to agreements made with content programmers. For example, these content viewing rules and restrictions may include supporting content blackouts (based on location or device) or content substitutions. In one embodiment, the media delivery system 1460 periodically pulls blackout information from programmers (for example, via agreed upon methods and timeframes). Additionally or alternatively, in one embodiment, the video streaming platform allows programmers to push blackout updates to the media delivery system 1460 through a cloud-hosted and secure Representational State Transfer (REST) Application Programming Interface (API) (for example, that adheres to SCTE-224). In one embodiment, the video streaming platform can accept blackout information in-band via SCTE-35. In one embodiment, blackout information can include information indicating one or more channels to be blacked out, a zip code to be blacked out, device type(s) to be blacked out, a time period for the blackout, or any combination thereof. The backend of the media delivery system 1460 may integrate with a geofencing library that maps client IP addresses to zip codes, which allows the video streaming platform to prevent or stop playback of video content as needed. This process may integrate with the stitching component 1560 or another component of the media delivery system 1460 so that custom slates can be inserted during blackouts as needed. In one embodiment, blackouts are instead indicated as part of program guide data or other metadata provided to the client electronic device 1400, for example, via a separate API, allowing the client electronic device 1400 to prevent playback of a blacked-out program

It should be understood that the particular division of functionality between the various system components shown in FIG. 15 is provided by way of example and is not intended to be limiting. Functions performed by a single system component may instead be performed by multiple system components and functions performed by multiple system components may instead be performed by a single system component.

An embodiment may be an article of manufacture in which a non-transitory computer-readable medium (such as microelectronic memory) has stored thereon instructions (e.g., computer code) which program one or more data processing components (generically referred to here as a “processor”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

While the several embodiments have described, those skilled in the art will recognize that the techniques described herein are not limited to the embodiments described, but can be practiced with modification and alteration within the spirit and scope of the appended claims. The description is thus to be regarded as illustrative instead of limiting.

What is claimed is:

1. A method performed by a media delivery system providing a media delivery service, the method comprising:
selecting a plurality of video assets to be included in a dynamic channel for a user of the media delivery service based on a user profile of the user; and
causing a client device of the user to display an electronic programming guide graphical user interface (EPG GUI) on a display screen, wherein the EPG GUI displays time schedule information for one or more linear channels alongside information regarding a first video asset from the plurality of video assets included in the dynamic channel, wherein the EPG GUI further displays a first GUI element that is activatable by the user to cause the first video asset to be played for the user and a second GUI element that is activatable by the user to cause the EPG GUI to display information regarding a second video asset from the plurality of video assets included in the dynamic channel and to display a third GUI element that is activatable by the user to cause the second video asset to be played for the user.

2. The method of claim 1, wherein the EPG GUI further displays a representative image of the second video asset with the second GUI element.

3. The method of claim 1, wherein the dynamic channel is a branded dynamic channel and the plurality of video assets included in the dynamic channel is selected from a library of video assets associated with a brand of the branded dynamic channel.

4. The method of claim 3, wherein the branded dynamic channel is also made available to other users of the media delivery service, wherein different sequences of video assets are selected to be included in the branded dynamic channel for different users of the media delivery service.

5. The method of claim 3, wherein the one or more linear channels include a linear version of the branded dynamic channel.

6. The method of claim 1, wherein the one or more linear channels follow a predetermined time schedule of video contents and the dynamic channel does not follow a predetermined time schedule.

7. The method of claim 1, wherein the time schedule information for the one or more linear channels includes information regarding start times of video contents of the one or more linear channels.

8. The method of claim 1, wherein the information regarding the first video asset includes a representative image of the first video asset, a title of the first video asset, and a textual description of the first video asset.

9. The method of claim 1, wherein the user profile of the user includes information regarding one or more of: the user's previous viewing history, the user's demographic, the user's current location, a current time at the user's current location, and the user's feedback regarding the user's favorite video content.

10. The method of claim 1, wherein the plurality of video assets included in the dynamic channel is selected to be included in the dynamic channel when the user logs in to the media delivery service or when the user accesses the EPG.

11. The method of claim 1, wherein the second GUI element, when activated by the user, causes the EPG GUI to further display a fourth GUI element that is activatable by the user to cause the EPG GUI to display information regarding a third video asset from the plurality of video assets included in the dynamic channel.

12. The method of claim 1, wherein the causing the client device of the user to display the EPG GUI on the display screen comprises: transmitting the time schedule information for one or more linear channels and the information regarding a first video asset to the client device of the user over a communication network.

13. The method of claim 1, further comprising:
causing the first video asset to be played for the user as a result of the user activating the first GUI element; and
causing the client device of the user to display a playback GUI for the first video asset on the display screen, wherein the playback GUI for the first video asset includes a fourth GUI element that is activatable by the user to cause the second video asset to be played for the user.

14. A non-transitory machine-readable storage medium that provides instructions that, when executed by a media delivery system providing a media delivery service, cause the media delivery system to perform operations comprising:
selecting a plurality of video assets to be included in a dynamic channel for a user of the media delivery service based on a user profile of the user; and
causing a client device of the user to display an electronic programming guide graphical user interface (EPG GUI) on a display screen, wherein the EPG GUI displays time schedule information for one or more linear channels alongside information regarding a first video asset from the plurality of video assets included in the dynamic channel, wherein the EPG GUI further displays a first GUI element that is activatable by the user to cause the first video asset to be played for the user and a second GUI element that is activatable by the user to cause the EPG GUI to display information regarding a second video asset from the plurality of video assets included in the dynamic channel and to display a third GUI element that is activatable by the user to cause the second video asset to be played for the user.

15. The non-transitory machine-readable storage medium of claim 14, wherein the EPG GUI further displays a representative image of the second video asset with the second GUI element.

16. The non-transitory machine-readable storage medium of claim 14, wherein the dynamic channel is a branded dynamic channel and the plurality of video assets included in the dynamic channel is selected from a library of video assets associated with a brand of the branded dynamic channel.

17. The non-transitory machine-readable storage medium of claim 16, wherein the branded dynamic channel is also made available to other users of the media delivery service, wherein different sequences of video assets are selected to be included in the branded dynamic channel for different users of the media delivery service.

18. The non-transitory machine-readable storage medium of claim 16, wherein the one or more linear channels include a linear version of the branded dynamic channel.

19. A method performed by a client device of a media delivery system providing a media delivery service, the method comprising:
receiving, from the media delivery system, time schedule information for one or more linear channels and information regarding a first video asset included in a dynamic channel, wherein the media delivery system selected a plurality of video assets including the first video asset and a second video asset to be included in the dynamic channel; and
causing an electronic programming guide graphical user interface (EPG GUI) to be displayed on a display screen, wherein the EPG GUI displays the time schedule information for the one or more linear channels alongside the information regarding the first video asset included in the dynamic channel, wherein the EPG GUI further displays a first GUI element that is activatable by the user to cause the first video asset to be played for the user and a second GUI element that is activatable by the user to cause the EPG GUI to display information regarding the second video asset and to display a third GUI element that is activatable by the user to cause the second video asset to be played for the user.

20. The method of claim 19, further comprising:
causing the first video asset to be played for the user on the display screen as a result of the user activating the first GUI element; and
causing a playback GUI for the first video asset to be displayed on the display screen, wherein the playback GUI for the first video asset includes a fourth GUI element that is activatable by the user to cause the second video asset to be played for the user.
